(19) United States
(12) Patent Application Publication
(10) Pub. No.: US 2019/0329305 A1
(43) Pub. Date: Oct. 31, 2019

(54) FUME HOOD AIR CHANNELING DEVICE

(71) Applicant: Timothy McKibben, Colorado Springs, CO (US)

(72) Inventor: Timothy McKibben, Colorado Springs, CO (US)

(21) Appl. No.: 15/962,966

(22) Filed: Apr. 25, 2018

(51) Int. Cl. B08B 15/02

(52) U.S. Cl. CPC B08B 15/023

(57) ABSTRACT

In one embodiment, a fume hood equipment support system may include a platform having a plurality of vertical air channels therethrough, support legs configured to hold the platform above the work surface of a fume hood, and an air chamber formed beneath the platform. The platform may include a lattice of interconnected horizontal slats forming a plurality of vertical air channels through the platform. The platform may have sidewall surfaces, an upper surface and a lower surface. The support legs may be attached to the platform to hold the platform above the work surface of fume hood. The work surface and the lower surface of the platform may form the air chamber beneath the platform. The air chamber may be in fluid communication with the vertical air channels. The sidewall surfaces, the upper surface and the lower surface may together define a bulk volume of the platform, the bulk volume having void space defined by the vertical air channels. In on example, the bulk volume comprises at least 50% void space.

### BACKGROUND

The present disclosure relates generally to accessories for laboratory fume hoods. In particular devices for channeling air and supporting equipment within the fume hood are described.

Existing methods of using laboratory fume hoods are not entirely satisfactory for the range of applications in which they are employed. For example, existing fume hoods may become clogged with equipment, obstructing air flow where it is needed most and causing dangerous conditions within the hood.

Thus, there exists a need for systems that improve upon and advance the design of existing fume hoods. Examples of new and useful systems relevant to the needs existing in the field are discussed below.

### SUMMARY

In one embodiment, a fume hood equipment support system may include a platform having a plurality of vertical air channels therethrough, support legs configured to hold the platform above the work surface of a fume hood, and an air chamber formed beneath the platform. The platform may include a lattice of interconnected horizontal slats forming a plurality of vertical air channels through the platform. The platform may have sidewall surfaces, an upper surface and a lower surface. The support legs may be attached to the platform to hold the platform above the work surface of fume hood. The work surface and the lower surface of the platform may form the air chamber beneath the platform. The air chamber may be in fluid communication with the vertical air channels. The sidewall surfaces, the upper surface and the lower surface may together define a bulk volume of the platform, the bulk volume having void space defined by the vertical air channels. In on example, the bulk volume comprises at least 50% void space.

### BRIEF DESCRIPTION OF THE DRAWINGS

FIG. 1 is a perspective view of a first example of a fume hood air channeling device.

FIG. 2 is a perspective view of the fume hood air channeling device of FIG. 1 depicting equipment in place and in use in the fume hood.

FIG. 3 is a perspective view of the fume hood air channeling device of FIG. 1 depicting equipment in use in the fume hood.

FIG. 4 is a detail view of a portion of the fume hood air channeling device of FIG. 1 depicting the vertical air channels.

FIG. 5 is a plan view of the fume hood air channeling device of FIG. 1 in place in a fume hood.

### DETAILED DESCRIPTION

The disclosed fume hood air channeling devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various fume hood air channeling devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

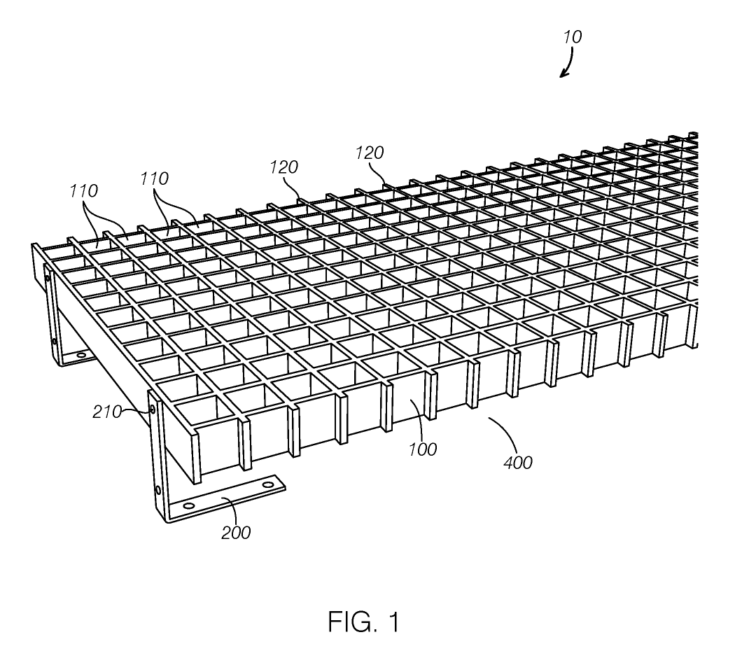

With reference to FIGS. 1-5, a first example of a fume hood air channeling device, device 10, will now be described. Device 10 functions to distribute and channel air flow past the equipment in a fume hood. The reader will appreciate from the figures and description below that Device 10 addresses shortcomings of conventional fume hoods.

Device 10 includes a platform 100 including vertical air channels 110, support legs 200 and an air chamber 400.

As can be seen in FIG. 1, platform 100 may be comprised of a lattice of interconnected horizontal slats 120 which form a plurality of vertical air channels 110. In the illustrated embodiment, the vertical air channels 110 have a rectangular cross section. In other embodiments, the vertical air channels may have any other suitable shape such as cylinders.

The platform 100 may be sized to fit within a laboratory fume hood. In one embodiment, platform 100 may be sized to essentially match the dimensions of the countertop work surface inside of a laboratory fume hood. In other embodiments, the platform may be sized to cover only a portion of the fume hood work surface, for example approximately half the work surface. The platform 100 may have an upper surface and a lower surface.

Support legs 200 function to hold platform 100 above the work surface of the fume hood. For example, the support legs 200 may position the platform 100 such that the lower surface of the platform 100 is several inches above, and essentially parallel with, the countertop work surface in the fume hood. Thus, a long horizontal air chamber 400 may be formed beneath platform 100.

Support legs 200 may be attached to platform 100 via fasteners 210. In the illustrated embodiment, the support legs comprise L-shaped metal bodies. In other embodiments, the support legs 200 may comprise cylindrical or tubular members. The support legs may be made of plastic, glass, carbon, metal and/or composite. In some embodiments, the support legs may be adjustable in height. For example the support legs 200 may include a series of holes sized to accept the fastener 210, thus the height of the support legs may be adjusted by selecting another one of the series of holes to place the fastener 210 though. In other embodiments, the support legs may be telescoping or otherwise adjustable.

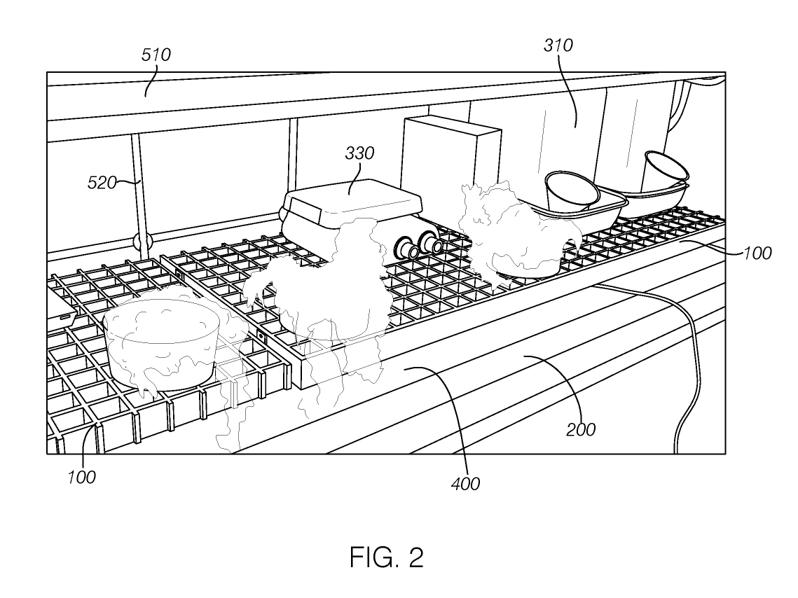

Turning now to FIG. 2, the air chamber 400 functions to distribute air to each of the vertical air channels 110. Laboratory equipment 310, 330 may be placed on the upper surface of platform 100, as shown. Thus, by placing device 10 beneath the laboratory equipment 310, 330, the air flow on all sides of the equipment may be drastically increased as compared with placing the equipment directly on the work surface of the fume hood 500.

The platform may be constructed of plastic, glass, carbon, metal and/or composite. In one embodiment, the platform 200 is comprised of one or more materials having a Class A fire rating, as defined by the National Fire Protection Association (NFPA).

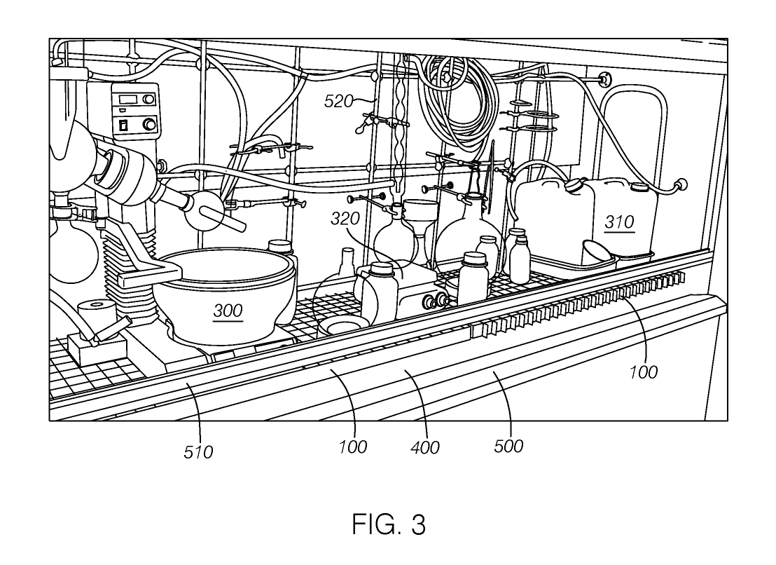

Turning now to FIG. 3, in one embodiment, the fume hood sash 510 may be lowered such that the air chamber 400 is open to the ambient environment to collect air, while the equipment 300, 310 in the hood is behind the clear glass of the hood. Thus, the airflow around the equipment may be maintained even while the equipment is behind the protective glass.

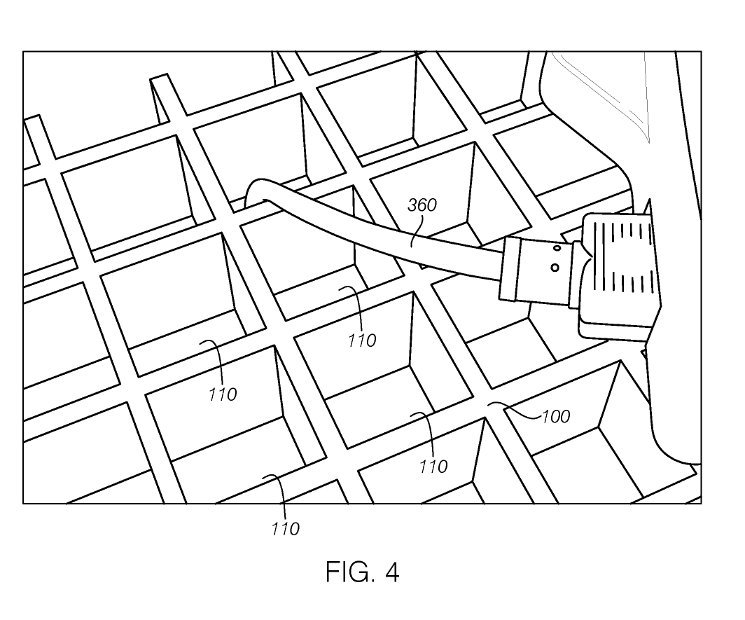

Turning now to FIG. 4, a detailed view of platform 100 is shown. As can be seen, an the vertical air channels 110 may be sized such that an electrical plug 360 of a piece of equipment may be passed through the one of the vertical air channels 110. Thus, equipment requiring an electrical plug may be placed anywhere on the platform 100.

Furthermore, as can be seen in FIG. 4, the vertical air channels 110 define void space in the platform 100. The platform may have sidewall surfaces, wherein the sidewall surfaces together with the upper and lower surfaces define a bulk volume of the platform 100. In one embodiment, the bulk volume of the platform comprises at least 50% void space. In one embodiment, the bulk volume of the platform comprises at least 60% void space. In one embodiment, the bulk volume of the platform comprises at least 65% void space. In one embodiment, the bulk volume of the platform comprises at least 70% void space.

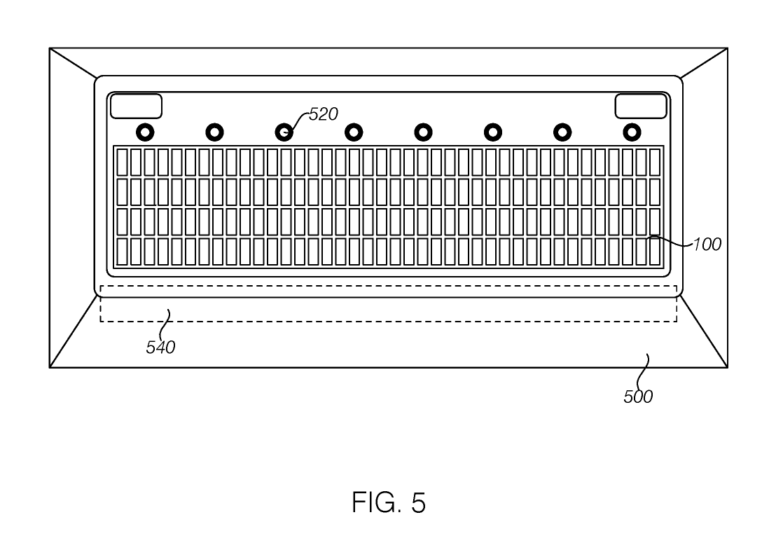

Turning now to FIG. 5, a plan view of platform 100 inside fume hood 200 is shown. As can be seen, the platform may extend side to side and front to back so as to be essentially coextensive with the work surface inside the fume hood 200. The platform 100 may extend from the lattice supports 520 at the back of the fume hood to the airfoil 540 at the front of the fume hood.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A fume hood air channeling system comprising:
a platform comprising a lattice of interconnected horizontal slats forming a plurality of vertical air channels through the platform, the platform having an upper surface and a lower surface; and
support legs attached to the platform, configured to hold the platform above a work surface of fume hood, the work surface and the lower surface of the platform forming an air chamber beneath the platform, the air chamber being in fluid communication with the vertical air channels.

2. The system of claim 1, wherein the platform has sidewall surfaces; and
wherein the sidewall surfaces, the upper surface and the lower surface together define a bulk volume of the platform, the bulk volume having void space defined by the vertical air channels.

3. The system of claim 2, wherein the bulk volume comprises at least 50% void space.

4. The system of claim 2, wherein the bulk volume comprises at least 60% void space.

5. The system of claim 2, wherein the bulk volume comprises at least 65% void space.

6. The system of claim 2, wherein the bulk volume comprises at least 70% void space.

7. The system of claim 1, wherein the vertical air channels have a rectangular opening.

8. The system of claim 1, wherein the vertical air channels are sized to pass an electrical plug therethrough.

9. The system of claim 1, wherein the platform is comprised of a material having a Class A Fire Rating, as defined by the National Fire Protection Association.

10. The system of claim 1, wherein the support legs are configured to be adjustable in height.

11. A fume hood air channeling system comprising:
a platform comprising a lattice of interconnected horizontal slats forming a plurality of vertical air channels through the platform, the platform having sidewall surfaces, an upper surface and a lower surface; and
support legs attached to the platform, configured to hold the platform above a work surface of fume hood, the work surface and the lower surface of the platform forming an air chamber beneath the platform, the air chamber being in fluid communication with the vertical air channels; and
wherein the sidewall surfaces, the upper surface and the lower surface together define a bulk volume of the platform, the bulk volume having void space defined by the vertical air channels.

12. The system of claim 11, wherein the bulk volume comprises at least 50% void space.

13. The system of claim 11, wherein the bulk volume comprises at least 60% void space.

14. The system of claim 11, wherein the bulk volume comprises at least 65% void space.

15. The system of claim 11, wherein the bulk volume comprises at least 70% void space.

16. The system of claim 11, wherein the vertical passages have a rectangular opening.

17. The system of claim 11, wherein the vertical air channels are sized to pass an electrical plug therethrough.

18. The system of claim 11, wherein the platform is comprised of a material having a Class A Fire Rating, as defined by the National Fire Protection Association.

19. The system of claim 11, wherein the support legs are configured to be adjustable in height.

20. A fume hood air channeling system comprising:
a platform comprising a lattice of interconnected horizontal slats forming a plurality of vertical air channels through the platform, the platform having sidewall surfaces, an upper surface and a lower surface; and
support legs attached to the platform, configured to hold the platform above a work surface of fume hood, the work surface and the lower surface of the platform forming an air chamber beneath the platform, the air chamber being in fluid communication with the vertical air channels; and
wherein the sidewall surfaces, the upper surface and the lower surface together define a bulk volume of the platform, the bulk volume having void space defined by the vertical air channels;
wherein the bulk volume comprises at least 50% void space.
